(19) United States
(12) Patent Application Publication
(10) Pub. No.: US 2021/0121828 A1
(43) Pub. Date: Apr. 29, 2021

(54) A POLYELECTROLYTE-BASED SACRIFICIAL PROTECTIVE LAYER FOR FOULING CONTROL IN DESALINATION AND WATER FILTRATION

(71) Applicant: The Penn State Research Foundation, University Park, PA (US)

(72) Inventors: Moon Son, State College, PA (US); Bruce E. Logan, State College, PA (US); Wulin Yang, State College, PA (US); Johannes Vrouwenvelder, Thuwal (SA); Szilard Bucs, Thuwal (SA)

(73) Assignee: KING ABDULLAH UNIVERSITY OF SCIENCE AND TECHNOLOGY, Thuwal, Kingdom of Saudi Arabia (SA)

(21) Appl. No.: 17/253,825

(22) PCT Filed: Jun. 21, 2019
(86) PCT No.: PCT/US2019/038428

§ 371 Date: Dec. 18, 2020

Related U.S. Application Data
(60) Provisional application No. 62/688,082, filed on Jun. 21, 2018.

(51) Int. Cl. B01D 65/08; C02F 1/44; B01D 65/02

(52) U.S. Cl. CPC B01D 65/08; C02F 1/441; B01D 65/02; C02F 2303/20; B01D 2325/16; B01D 2323/40; B01D 2321/168; B01D 2325/14

(57) ABSTRACT

A method of providing fouling control in a membrane system includes generating a sacrificial protective layer (PL) on a surface of a membrane of the membrane system by coating the membrane with at least one polyelectrolyte layer, removing the PL from the membrane with a saline solution after the PL is fouled, and regenerating a new PL on the surface of the membrane by coating the membrane with at least one polyelectrolyte layer such that foulants present in a feed water accumulate on the PL, rather than on the membrane. The method further comprises one or more of the following: a) the saline solution is being applied with a shear force; b) the pH value of the saline solution is substantially neutral; c) the saline solution is non-toxic; d) the PL is removed without a backwash; e) the PL is not an active filtration layer, wherein a pore size of the PL is greater than a pore size of the membrane; and/or f) the PL is not disposed in pores of the membrane.

### CROSS REFERENCE TO RELATED APPLICATIONS

This application is the U.S. National Stage of PCT/US2019/038428 filed Jun. 21, 2019, which claims priority from U.S. Provisional Patent Application U.S. Ser. No. 62/688,082 filed on Jun. 21, 2018, the entire content of both are incorporated herein by reference in their entirety.

### FIELD OF THE INVENTION

The present invention relates to fouling control and foulant removal of a membrane system.

### BACKGROUND OF THE INVENTION

Membrane fouling is one of the most challenging issues that need to be addressed in membrane systems such as RO, MF, UF, NF, PRO, MD as well as other systems involving water, e.g., cooling towers, paper industry, dairy industry, sensors, and transport pipes and reservoirs. Membrane fouling is an inevitable phenomenon during membrane filtration, which significantly decreases efficiency of a filtration system. Fouling inevitably decreases the water flux and/or the pressure drop of a membrane system due to the accumulation of solids on the membrane and spacer. So far, methods reported to mitigate or alleviate this fouling phenomenon include surface hydrophobicity control, blush polymer grafting, and functional material incorporation. However, those techniques still require complicated post-treatment of the membrane, have high costs, and there can be leaching problems of unbound functional materials.

For example, most RO membranes are currently made with a thin film of an active layer of polyamide, coated onto a structural support layer. Typical methods used to mitigate fouling of the polyamide layer are based on altering the membrane surface based on making it less hydrophobic, bonding polymers to the surface to create a steric barrier between the membrane and the foulant, or adding materials such as graphene oxide, carbon nanotube, and mesoporous carbons into the membrane to reduce the adhesion of foulants onto the surface. However, all these approaches might delay, but do not prevent or control, fouling so that periodic aggressive cleaning methods are still needed to remove the accumulated foulants that are tightly bound to the membrane surface.

An alternative approach to dealing with membrane fouling is to construct the membrane using more chemical-resistant active layers than polyamide. Several approaches have been used to obtain high performance membranes in terms of permeability and resistance to chemicals. However, these previous approaches require complex fabrication methods and a large number of active layers to achieve commercial standards of selectivity of over 99% rejection of sodium chlorine. For example, at least ten bi-layers were needed to fabricate a RO membrane with a high rejection rate using polyelectrolytes. Thermal annealing can be required, which can result in a large reduction in membrane permeability. The alternative is to use chemicals such as glutaraldehyde to bond multiple layers together, but this can create the potential for leaching this toxic chemical into the treated water. Without thermal annealing or chemical bonding of these layers, the membranes will have low selectivity for the salt ions and will not have sufficient rejection properties or permeabilities needed for RO desalination.

### SUMMARY OF THE INVENTION

Embodiments of the present invention provide a method of providing fouling control in a membrane system. The method includes the steps of generating a sacrificial protective layer (PL) on a surface of a membrane of the membrane system by coating the membrane with one or more polyelectrolyte layers, such that foulants present in a feed water accumulate on the PL, rather than on the membrane. After the PL is fouled, the PL may be removed from the membrane with a saline solution. Then a new PL can be regenerated on the surface of the membrane by coating the membrane with multiple polyelectrolyte layers. The feed water will be shut off when the PL is regenerated.

In some versions, the PL is not an active filtration layer. The pore size of the PL is greater than the pore size of the membrane. In an embodiment, the membrane has a pore side of <1 nm.

The presence of the PL on the membrane may only slightly decrease the membrane permeability and increase the salt rejection compared to the pristine membrane. In some embodiments, the PL is not disposed in pores of the membrane. In some embodiments, the PL can be removed using a saline solution with a substantially neutral pH value without a backwash. In some embodiments, the saline solution is non-toxic. Avoiding the backwash also eliminates the chances of the clean water side being contaminated. The saline solution may have a salt concentration of 0.5-3 M NaCl. A shear force may be applied when removing the PL. In an embodiment, the shear force is applied by stirring at an rpm greater than 300.

In another embodiment, the shear force is generated by using a bubbled gas solution.

The velocity of stirring for applying the shear force may be dependent on the salt concentration of the saline solution.

The PL may include one polyelectrolyte layer or multiple polyelectrolyte layers. The PL may include at least one bi-layer. In some embodiments, the PL may include 1-10 bi-layers. Each bi-layer comprises a positively-charged layer and a negatively-charged layer. The layers of the multiple layers are attached to one another via electrostatic attraction. The membrane might be negatively or positively charged. The PL is attached to the backbone membrane via electrostatic attraction without a chemical bond.

The layer-by-layer method may include coating a first positively-charged layer using a cationic polyelectrolyte on the surface of the negatively-charged membrane and then coating a first negatively-charged layer using an anionic polyelectrolyte on a surface of the first positively-charged layer.

The layer-by-layer method may further include generating a second positively-charged layer using a cationic polyelectrolyte on the surface of the first negatively-charged layer and then generating a second negatively-charged layer using an anionic polyelectrolyte on a surface of the second positively-charged layer and continuing a cycle of alternating polycations and polyanions to form additional bi-layers.

The layer-by-layer method may include spraying polyelectrolyte solutions onto the membrane surface. The spraying may have a velocity of >0.16 m/s.

In another embodiment, generating and regenerating the PL may use a solution drop method by dropping solution droplets into the feed water.

In an example, the cationic polyelectrolyte is poly(diallyl-dimethylammonium chloride) (PDDA) and the anionic polyelectrolyte is poly(sodium-4-styrenesulfonate) (PSS).

### BRIEF DESCRIPTION OF THE INVENTION

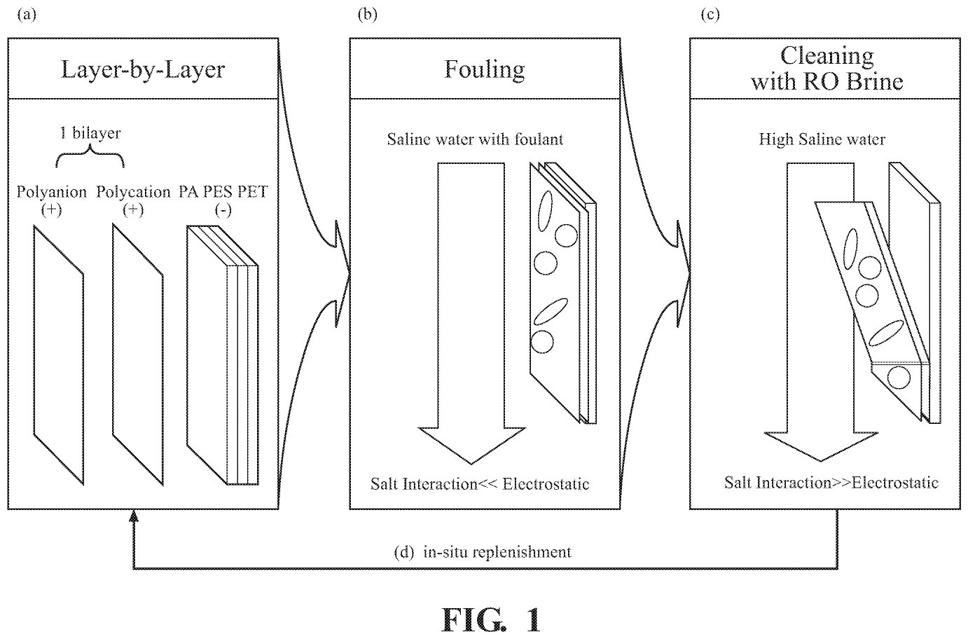

FIG. 1a is a schematic showing layer-by-layer coating of a sacrificial protective layer (PL);

FIG. 1b is a schematic showing thin-film composite (TFC) membrane fouling onto the PL;

FIG. 1c is a schematic showing detachment of the PL together with accumulated foulant by flushing high saline water such as a RO brine;

FIG. 1d shows in-situ replenishment of the PL to protect the TFC membrane;

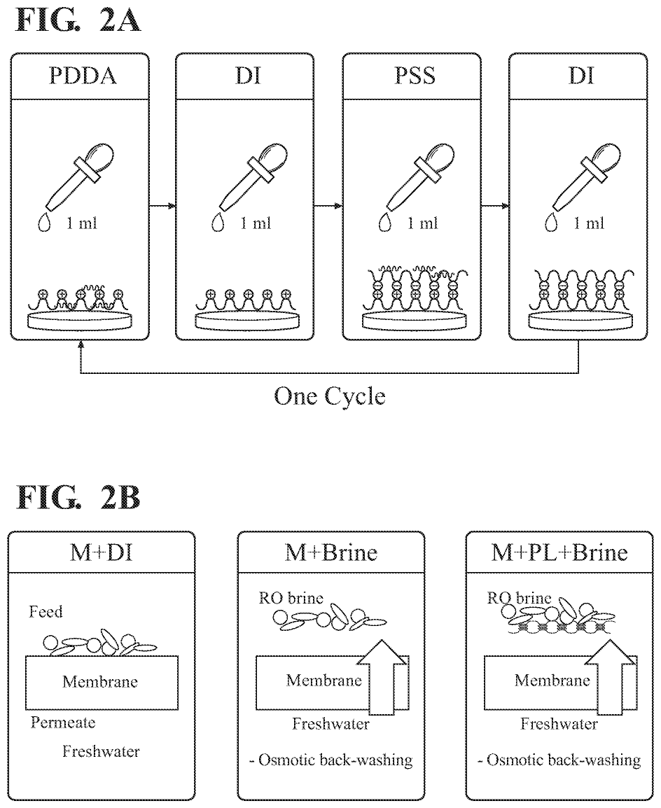

FIG. 2a is a schematic showing in-situ replenishment of a polyelectrolyte layer;

FIG. 2b is a schematic showing the effect of osmotic back-washing due to the different salinity in a feed and a permeate side;

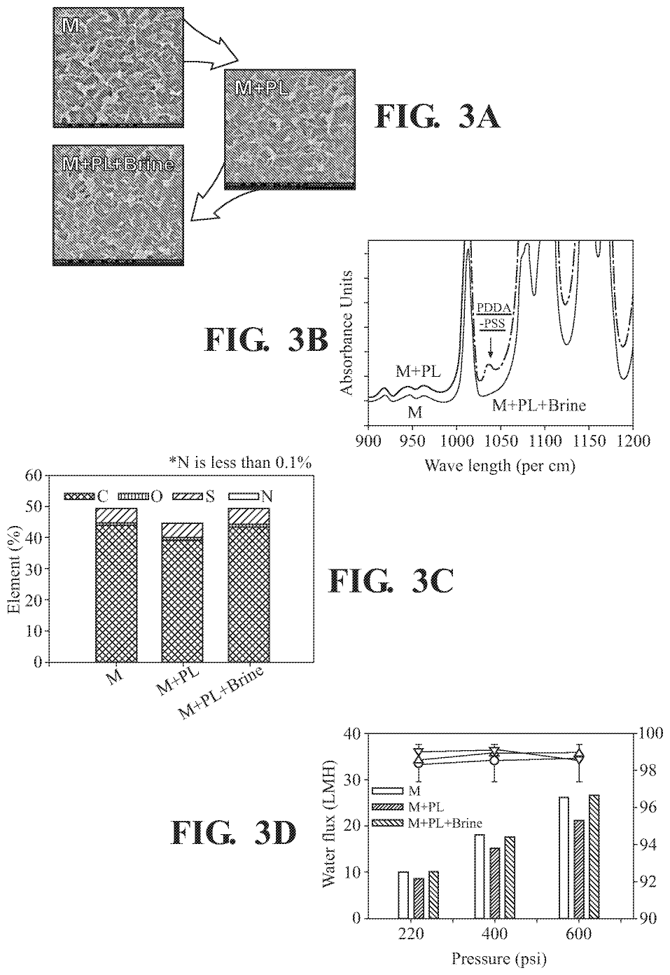

FIG. 3a shows images of the morphology of the surface by SEM showing physico-chemical properties of prepared membranes;

FIG. 3b is a plot showing functional groups by FT-IR spectroscopy;

FIG. 3c is a graph by SEM-EDS showing element compositions;

FIG. 3d is a graph showing permselectivity of prepared membranes in terms of water flux and rejection as a function of pressure;

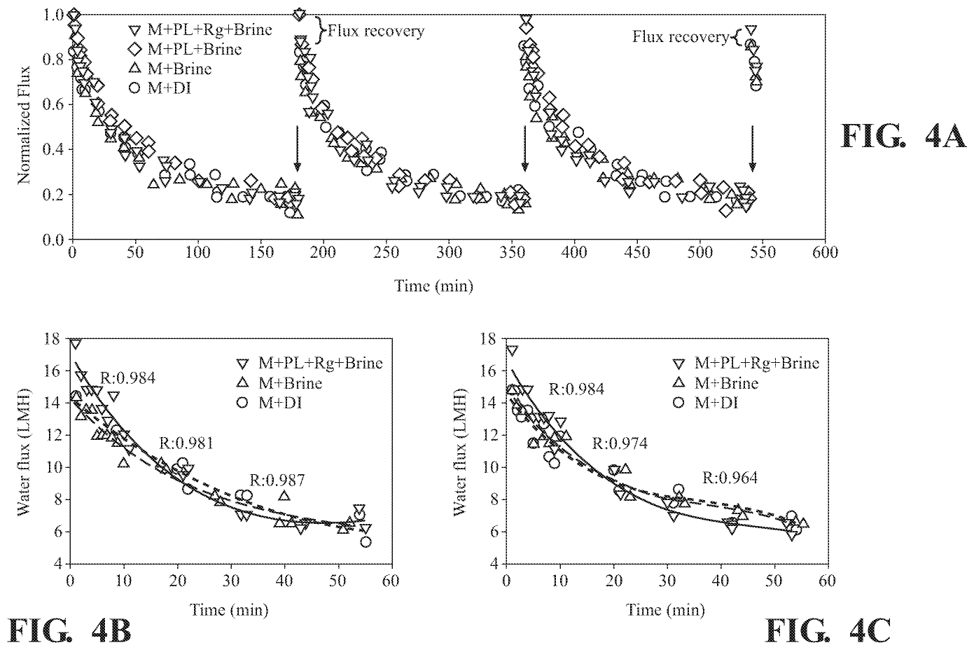

FIG. 4a is a plot showing four consecutive fouling tests using alginate as a model foulant;

FIG. 4b is a plot showing water flux decline during the 2^{nd} cycle of the fouling;

FIG. 4c is a plot showing water flux decline during the 3^{rd} cycle of the fouling;

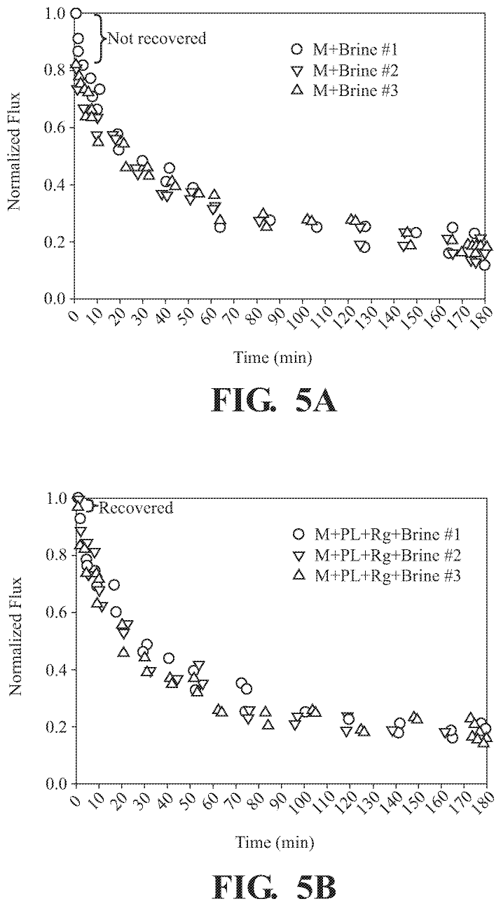

FIG. 5a is a plot showing fouling and flux recovery tendency for a pristine membrane;

FIG. 5b is a plot showing the developed membrane over four cycles using alginate as a model foulant;

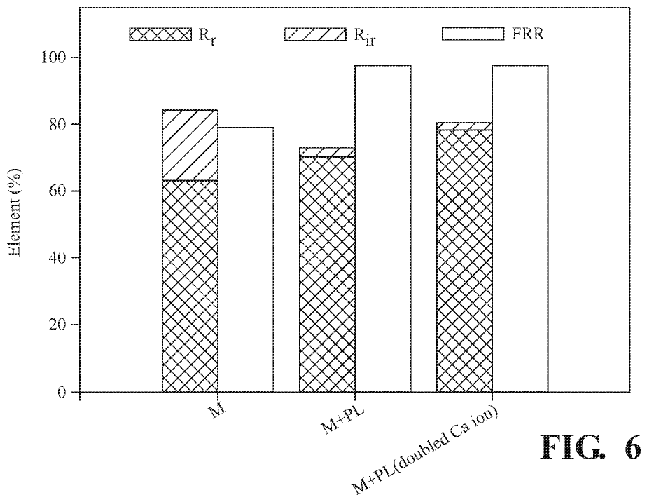

FIG. 6 is a graph showing the effect of calcium ions on cleaning efficiency via a bridge-effect (Rr: reversible fouling ratio, RH.: irreversible fouling ratio, FRR: flux recovery ratio);

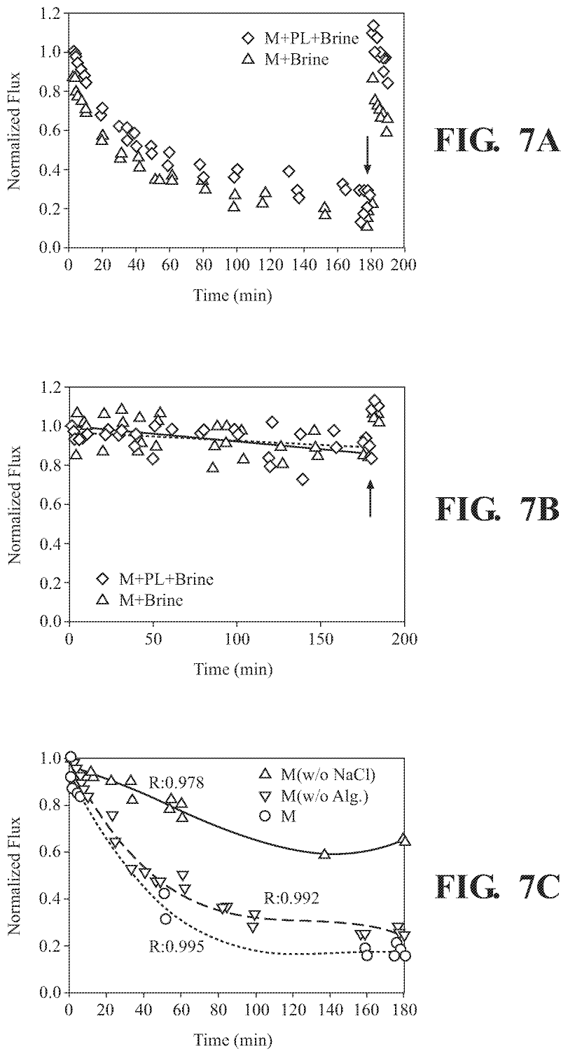

FIG. 7a is a plot showing the effect of loosely bound fouling on water flux using 20 ppm alginate instead of 200 ppm;

FIG. 7b is a plot showing the effect of loosely bound fouling on water flux with 60 rpm stirring applied during fouling, with other fouling conditions the same as FIG. 7a; and

FIG. 7c is a plot showing the role of alginate and sodium chloride on flux decline over time (100 ppm Ca²⁺ ion was added for all cases).

### DETAILED DESCRIPTION OF THE INVENTION

The present invention provides an approach for fouling control for membrane systems, by using a sacrificial protective layer (PL) coated on top of the membrane of a membrane system. The PL may be formed by multiple polyelectrolyte polymer layers. The PL may be applied without any linker to chemically bond the material to the membrane surface, as the layer does not need to be attached to the membrane during backwashing, cleaning or removing. One polyelectrolyte layer is attached to another polyelectrolyte layer without any linker or glue.

When the PL is on the membrane surface, any foulants present in a feed water may accumulate on the surface of the PL, rather than on the membrane. After the PL is fouled, it is removed together with the foulants by a simple flushing of the membrane with a highly saline solution, such as the RO brine, which causes the PL to detach due to a loss in its stability on the membrane surface at a high salt concentration or due to a shear force or due to both.

Thus, the problem of a membrane coating instability under higher saline conditions, which has been considered as a weakness of previous polyelectrolyte additions to the membrane in desalination systems is used as an advantage here for easy detachment of the PL in the present approach. After cleaning using the brine solution, the PL layer can be replenished in-situ by producing a new sacrificial protective layer on top of the membrane, which allows the backbone membrane to be reusable, thus expanding its lifespan.

The PL may be a single layer. The membrane may be negatively or positively charged. The PL layer can be selected to have an opposite charge to that of the membrane. The PL may also be formed as a bi-layer or multiple bi-layers. Each bi-layer may include a positively-charged layer and a negatively-charged layer. There may be 1-10 bi-layers to form a PL. The PL is attached to the backbone membrane by the electrostatic attraction.

When forming a PL for a negatively-charged membrane, the positively-charged layer is coated onto the membrane first, and then the negatively-charged layer is coated onto the positively-charged layer. The subsequent bi-layer is formed on the preceding bi-layer already formed on the membrane. When forming a PL for a positively-charged membrane, the coating step of the negatively-charged layer followed by the positively-charged layer can be used. A negatively-charged layer can be formed using polycations. A positively-charged layer can be formed using polyanions. The PL can be generated by using a layer-by-layer method with a cycle of alternating polycations and polyanions to form each bi-layer.

Coating the PL can include a spraying method or a solution method. A spraying method includes spraying polyelectrolyte solutions onto the membrane surface. The velocity used for spraying may be in the range of >0.16 m/s.

The solution method may involve dropping polyelectrolyte solution droplets into the membrane surface, or otherwise adding a polyelectrolyte solution to the feed channel. The polycations and polyanions in the water will be attracted by the negatively or positively charged membrane to form a PL.

A backbone membrane is provided to coat the PL on. The membrane may have a pore size small enough to filter out ions in the water. The foulant particles can be as big as a few hundred nm. The pore size of the membrane may be smaller than 1 nm. The PL is coated on the membrane but does not function as an active filtration layer. An active filtration layer is the layer provides the pore size of the filtration membrane. The PL may have a pore size larger than the pore size of the membrane in order to prevent adversely effect on the water flux. The PL is only coated on the surface of the membrane and not disposed in the pores of the membrane. The stacking of the multiple polyelectrolyte layers may be used to control the pore size of the PL.

To remove or detach the PL from the membrane, a high concentration of saline solution may be used. In some embodiments, the saline solution is flushed onto the membrane with a shear force. The salt concentration of the saline solution is dependent on the shear force and may be in the range of 0.5-3 M NaCl. When the shear force is high, the salt concentration of the saline solution may be lower than the salt concentration of the saline solution when a lower shear force is used. If there is no shear force, any physico-chemical alternative force is needed to remove the sacrificial PL. The shear force can be generated by stirring at an rpm greater than 300 rpm, such as 600 rpm. In some embodiments, the shear force can be generated by creating air bubbles in the solution using, for example, hydrogen peroxide.

The pH value of the saline solution may be substantially neutral, i.e., in the range of ±5% of pH value 7. The saline solution used in the present invention is preferably non-toxic, i.e., it does not leach any harmful particles for humans into the solution. NaCl is preferred.

In one embodiment of the present invention, the cation polyelectrolyte used is poly(diallyl-dimethylammonium chloride) (PDDA) and the anionic polyelectrolyte used is poly(sodium-4-styrenesulfonate) (PSS). Both PDDA and PSS are not toxic. No linker or glue is used to attach the PL to the membrane and to attach multiple layers to one another, leaching no harmful chemicals into the water either.

Without using glue or linkers to attach the PL, the PL may be removed without needing a trigger of a pH change or backwash. Backwashing can be used but it is not required. Eliminating backwashing also minimizes the contamination of the clean water. The PL is bonded to the membrane without using heat or chemical approaches. Therefore, the PL could be easily added and detached without appreciably impacting membrane permeability and selectivity. When the salt interaction force is stronger than electrostatic attraction between the PL and the backbone membrane, the PL can be removed by the highly saline water.

It is expected that most foulants in a feed water, such as dissolved organic or inorganic matter, as well as particulate matter, could be removed by the present method as the PL provides a sacrificial adsorption layer and a physical barrier for direct adhesion onto the membrane surface.

### Embodiments

### Coating Protective Layers

In one example, two polyelectrolytes are used here to produce the PL having a bi-layer, including a cation polymer, poly(diallyl-dimethylammonium chloride) (PDDA), and an anionic polymer, poly(sodium-4-styrenesulfonate) (PSS). FIGS. 1a-1d show a schematic of four steps used to synthesize a replenishable thin-film composite (TFC) membrane. A commercial reverse osmosis (RO) membrane (SW30HR, Dow Chemical) was used as a backbone membrane. In FIG. 1a, PA represents polyamide. PES represents polyethersulfone. PET represents polyethylene terephthalate.

The first PL was applied using a layer-by-layer method to form a uniform film, shown in FIG. 1a. In this example, the surface of the membrane is negatively charged. PDDA and PSS (10 g each) were dissolved in deionized (DI) water, and 5 mL of each solutions were sprayed for 1 min on an effective membrane area, 14.6 cm₂ to form a single bi-layer. The PDDA solution, which is a polycation, is sprayed first, followed with a spray of PSS solution which is a polyanion. Five bi-layers were coated onto the membrane. The membrane was flushed with 5 mL of DI water for 1 min after each polyelectrolyte coating to remove any unbound polyelectrolyte.

PDDA and PSS were chosen here, as they are not toxic chemicals and they are easy to apply. Other pairs of anionic and cationic polymers could also likely be used to fabricate a PL, such as polyvinyl alcohol, poly(allylamine hydrochloride), and sulfonated poly(etherketone). Multiple layers, for example one to 10 bi-layers, can be applied to the membrane.

In the example used here, five bi-layers were initially applied. To regenerate the membrane, multiple layers can again be applied.

### Fouling Experiments

After the initial fouling test, four consecutive fouling experiments were performed using a model foulant (200 ppm alginate) with a calcium ion binder (100 ppm), and synthetic brackish water (2000 ppm NaCl), as shown in FIG. 1b. Dead-end filtration experiments were conducted at 600 psi, with the normalized flux, flux recovery ratio, and reversible/irreversible fouling ratio calculated. Briefly, these factors were calculated using the initial water flux, the water flux of the fouled membrane, and initial water flux of the cleaned membrane. Additional experiments were conducted using a lower concentration of alginate (20 ppm) or with stirring (60 rpm) to examine the impact of concentration polarization relative to organic fouling on the water flux, which results will be described later.

The organic matter present in a feed water accumulates on the PL, rather than on the membrane.

### Membrane Cleaning

Cleaning was done after 3 hours of fouling using a high salt solution (70,000 ppm NaCl solution) (treatment) or DI water (control for salinity effects), as shown in FIG. 1c. For pristine membranes, cleaning was done using either the DI water (M+DI) or only high salt solution (M+Brine). For the PL coated membrane, the high salt solution was used as a cleaning agent (M+PL+Brine). Flushing was done by stirring (600 rpm) for 10 min.

### In-Situ Replenishment of the Protective Layer

When the PL was removed by brine cleaning, the PL was regenerated using an in-situ method, i.e., step (d) of FIG. 1, which is illustrated in detail in FIGS. 2a and 2b.

PDDA and PSS (each 1 mL) were successively added onto the membrane surface with a reaction time of 1 min and directly applied onto the membrane surface in the RO test chamber. After each reaction, the solution was discarded. DI water (1 mL for 1 min) was added onto the membrane surface after each reaction of the polyelectrolyte to remove the unbound polyelectrolyte, as shown in FIG. 2a. Membranes that were regenerated with a new PL were indicated by adding “Rg” to the membrane designation (M+PL+Rg+Brine). The membrane with a regenerated PL layer was further tested under the same fouling and cleaning conditions as other membranes, results of which will also be described later.

### Membrane Characterization

Scanning electron microscopy (SEM) was used to analyze the morphology of the membranes. Fourier-transform infrared spectroscopy (FTIR) was used to demonstrate the presence of the PL coating. A scanning electron microscopy/energy dispersive X-ray spectroscopy (SEM-EDS) analysis was used to obtain the elemental composition of both the PL-coated and uncoated membranes. Permeability (water flux) and selectivity (rejection) of membranes obtained as a function of pressure (220 to 600 psi) were obtained using a synthetic brackish water (2,000 ppm NaCl) under dead-end filtration conditions (Sterlitech Corp., HP4750). The effective membrane area was 14.6 cm², with the cell pressurized using nitrogen gas.

Based on images obtained using SEM, as shown in FIG. 3a, there was no apparent change in the morphology of the membrane following addition of the PL, likely because the PL coating was designed to form a film of less than 10 nm in order to minimize permeability losses. Based on analysis using FTIR, an additional peak at 1035 to 1040 cm⁻¹ was produced for a PL-treated membrane, indicating the presence of the thin PL coating, and this peak was removed after brine flushing, as shown in FIG. 3b. SEM-EDS analysis showed in FIG. 3c a change in the elemental composition of the PL compared to the uncoated membranes. Both the functional group (FTIR) and element (SEM-EDS) analyses therefore indicated that the PL was successfully coated onto the membrane surface, and it could be removed by brine washing. Since salt interaction force is stronger than electrostatic attraction between the PL and the backbone membrane, the PL was removed by the highly saline water.

The presence of the PL on the membrane (M+PL) slightly decreased the membrane permeability and increased the salt rejection compared to the pristine membrane (M). In FIG. 3d, M refers to a pristine thin-film composite (TFC) membrane. M+PL refers to a TFC membrane possessing a polyelectrolyte-based protective layer (PL). M+PL+Brine refers to the PL detached membrane by brine flushing after the PL coating. As shown in FIG. 3d, both water permeability and salt rejection were restored to the same initial conditions after removal of the PL by washing with the high salt solution (M+PL+Brine). The addition of the PL maintained the high salt selectivity of the membrane (99%), unlike previously used processes where polyelectrolytes were bonded to the membrane using heat or chemical approaches. Therefore, the PL could be easily added and detached without appreciably impacting membrane permeability and selectivity.

### Fouling Control

FIG. 4a shows consecutive fouling tests using alginate as a model foulant. Cleaning was done after each three hours of fouling, indicated by the downward arrows. The in-situ replenishment of polyelectrolyte was conducted after cleaning for a developed membrane (M+PL+Rg+Brine). The performance of the PL-treated membranes was completely restored following the first membrane fouling cycle compared to controls. The PL coated membrane (M+PL+Brine) showed 100% flux recovery in the second fouling cycle as the foulant that accumulated on the PL was washed out together with the PL by high salt solution washing. For the un-coated membranes, there was a flux loss of ˜20% in the second cycle regardless of cleaning solution, using DI water (M+DI) or brine (M+Brine), shown in FIG. 4a. This showed that irreversible fouling occurred for the uncoated membranes, and that the foulant could not be dislodged by osmotic backwashing due to the salinity differences between feed and permeate solution, as illustrated in FIG. 2b. The irreversible fouling ratio of the PL coated membrane was only 3% due to the sacrificial layer of the PL, whereas it was ˜20% for the un-coated membrane and for the membranes treated with a brine cleaning agent, which is shown in FIG. 6.

In successive cycles, there was less flux recovery if the PL was not added after washing. However, the membranes that had in-situ replenishment of the PL showed a higher recovery flux recovery ratio than other membranes over the next two fouling cycles due to the brine cleaning and replenishment of the PL, as shown in FIGS. 4a, 5a and 5b. An average flux recovery ratio of 97±3% was achieved with the membrane coated with the PL (M+PL+Rg+Brine) over four fouling cycles, compared to 83±3% for the membrane without the PL (M+Brine).

It is expected that most foulants in a feed water, such as dissolved organic or inorganic matter, as well as particulate matter, could also be removed by this method as the PL provides a sacrificial adsorption layer and a physical barrier for direct adhesion onto the membrane surface.

### Water Production

FIGS. 4b and 4c show that water flux declined during 2^{nd} and 3^{rd} cycle of the fouling respectively. The PL coated membrane produced more water during the initial stage of fouling, due to the higher flux recovery, than the pristine membrane. In commercial applications of RO membranes for desalination, it is typically recommended that the membrane be cleaned before the water flux has declined to 90% of its initial value, and therefore we can consider the period for the first 10% decline in water flux. During that period, the PL coated membrane produced water of 15.5±0.6 L m⁻² h⁻² while it was 13.4±0.5 L m⁻² h⁻¹ for the pristine (untreated) membrane. Although water flux of the PL coated and uncoated membranes were similar when the water flux declined to 50% of its initial value, membrane cleaning would be needed before that point in practice. Therefore, the PL coated membrane exhibited superior performance in terms of water production under fouling conditions, which is one of the most challenging operational issues in desalination and water filtration.

### Impact of Chemical Concentrations

Among the ions present in seawater, calcium ions play an important role in membrane fouling as they bridge the membrane surface and negatively-charged foulants such as alginates, making it difficult to dislodge the foulant. When the concentration of calcium ion was doubled in the treated solution, however, as shown in FIG. 6, the fouling and recovery of the differently treated membranes was the same as that obtained with the original calcium ion concentration.

A very high concentration of the foulant (200 ppm) was used here in order to rapidly foul the membrane. Tests were also conducted at a lower concentration of 20 ppm, shown in FIG. 7a, in order to examine flux recovery under less severe fouling conditions. The same reduction in flux (80%) was obtained even at the lower foulant concentration, indicating that the increased concentration polarization due to the increased salt concentration over the cycle was the main reason for the reduction in water flux. Cleaning was done after each three hours of fouling indicated by the downward arrow. Following brine treatment and regeneration of the PL, the treated membrane still produced the same 100% recovery of water flux as that obtained at the higher foulant concentration. Additional tests were conducted to reduce concentration polarization by stirring the solution, shown in FIG. 7b. The decline in flux was only ˜10% over the same period of time (3 h) compared to tests without stirring. Even with stirring, as shown in FIG. 7b, the PL-treated membrane had a higher flux recovery than the control membrane. In the absence of the foulant and with no stirring, a similar flux decline of up to 80% was obtained, which is shown in FIG. 7c, indicating the main factor in the decline in the flux was due to concentration polarization and not the alginate in the later stages of fouling.

As will be clear to those of skill in the art, the embodiments of the present invention illustrated and discussed herein may be altered in various ways without departing from the scope or teaching of the present invention. Also, elements and aspects of one embodiment may be combined with elements and aspects of another embodiment. It is the following claims, including all equivalents, which define the scope of the invention.

1. A method of providing fouling control in a membrane system, the method comprising the steps of:
generating a sacrificial protective layer (PL) on a surface of a membrane of the membrane system by coating the membrane with at least one polyelectrolyte layer, such that foulants present in a feed water accumulate on the PL, rather than on the membrane;
after the PL is fouled, removing the PL from the membrane with a saline solution;
regenerating a new PL on the surface of the membrane by coating the membrane with at least one polyelectrolyte layer;
wherein the method further comprises one or more of the following:
a) the saline solution is being applied with a shear force;
b) the pH value of the saline solution is substantially neutral;
c) the saline solution is non-toxic;
d) the PL is removed without a backwash;
e) the PL is not an active filtration layer, wherein a pore size of the PL is greater than a pore size of the membrane; and/or
f) the PL is not disposed in pores of the membrane.

2. The method of providing fouling control in a membrane system according to claim 1, wherein the membrane is negatively charged.

3. The method of providing fouling control in a membrane system according to claim 1, wherein the at least one polyelectrolyte layer includes at least one bi-layer, each bi-layer comprising a positively-charged layer and a negatively-charged layer.

4. The method of providing fouling control in a membrane system according to claim 3, wherein the generating the PL includes using a layer-by-layer method with a cycle of alternating polycations and polyanions to form each bi-layer.

5. The method of providing fouling control in a membrane system according to claim 4, wherein the layer-by-layer method comprises coating a first positively-charged layer using a cationic polyelectrolyte on the surface of the membrane and then coating a first negatively-charged layer using an anionic polyelectrolyte on a surface of the first positively-charged layer.

6. The method of providing fouling control in a membrane system according to claim 5, wherein the layer-by-layer method further comprises generating a second positively-charged layer using a cationic polyelectrolyte on the surface of the first negatively-charged layer and then generating a second negatively-charged layer using an anionic polyelectrolyte on a surface of the second positively-charged layer.

7. The method of providing fouling control in a membrane system according to claim 1, wherein generating and regenerating the PL comprises spraying polyelectrolyte solutions onto the membrane surface or a solution method by adding a polyelectrolyte solution into the feed water.

8. The method of providing fouling control in a membrane system according to claim 4, wherein the cationic polyelectrolyte is poly(diallyl-dimethylammonium chloride) (PDDA) and the anionic polyelectrolyte is poly(sodium-4-styrenesulfonate) (PSS).

9. The method of providing fouling control in a membrane system according to claim 1, wherein the saline solution has a salt concentration of 0.5-3 M NaCl.

10. The method of providing fouling control in a membrane system according to claim 1, the method further comprising providing a membrane, wherein the membrane has a pore side of <1 nm.

11. The method of providing fouling control in a membrane system according to claim 1, wherein the PL has a pore size of >1 nm.

12. The method of providing fouling control in a membrane system according to claim 1, wherein the shear force is applied by stirring at an rpm greater than 300.

13. The method of providing fouling control in a membrane system according to claim 1, wherein the shear force is generated by using a bubbled gas solution.

14. The method of providing fouling control in a membrane system according to claim 9, wherein a velocity of stirring for applying the shear force is dependent on the salt concentration of the saline solution.

15. The method of providing fouling control in a membrane system according to claim 7, wherein the spraying has a velocity of >0.16 m/s.

16. The method of providing fouling control in a membrane system according to claim 3, wherein the at least one bi-layer includes 1-10 bi-layers.

17. The method of providing fouling control in a membrane system according to claim 3, wherein the PL is attached to the membrane by electrostatics without any glue or chemical bond and each layer of the PL is attached to one another by electrostatics without any glue or chemical bond.
